(19) United States
(12) Patent Application Publication
(10) Pub. No.: US 2009/0210750 A1
(43) Pub. Date: Aug. 20, 2009

(54) Systems And Methods For Identifying Memory Leaks In A Computer System

(75) Inventor: Claire S. Cates, Raleigh, NC (US)

Correspondence Address: PATENT GROUP 2N;JONES DAY, NORTH POINT, 901 LAKESIDE AVENUE, CLEVELAND, OH, 44114, US

(73) Assignee: SAS Institute Inc.

(21) Appl. No.: 12/033,593

(22) Filed: Feb. 19, 2008

(51) Int. Cl. G06F 11/00

(52) U.S. Cl. 714/42; 714/E11.002

(57) ABSTRACT

Systems and methods are provided for identifying memory leaks in a computer system. Testing software is inserted into one or more memory routines of a computer system to cause at least two successive tests of the memory routines during which the memory routines perform memory operations to allocate and de-allocate memory from a plurality of memory areas, such as pools or heaps. Information is captured that identifies at least a number of memory allocations and a number of memory de-allocations performed by the memory routines during the pendency of the tests. The captured information is compared to identify one or more candidate memory areas from the plurality of memory areas. A candidate memory areas is identified when the difference between the number of memory allocations and the number of memory de-allocations increases from one test to the next. Each candidate memory area is then evaluated further to identify any specific memory leaks within the memory area.

### FIELD

The technology described in this patent document relates generally to software and hardware testing.

### BACKGROUND AND SUMMARY

Computer systems that utilize memory allocation routines often incur errors in the form of memory leaks. A typical memory leak results when a pointer reference to a section of allocated memory is deleted or when a section of memory is allocated by the memory routine but is never freed. If undetected, memory leaks may cause significant problems, eventually causing the system to run out of memory.

In accordance with the teachings described herein, systems and methods are provided for identifying memory leaks in a computer system. Testing software is inserted into one or more memory routines of a computer system to cause at least two successive tests of the memory routines during which the memory routines perform memory operations to allocate and de-allocate memory from a plurality of memory areas, such as memory pools or heaps. Information is captured that identifies at least a number of memory allocations and a number of memory de-allocations performed by the memory routines during the pendency of the tests. The captured information is compared to identify one or more candidate memory areas from the plurality of memory areas. A candidate memory areas is identified when the difference between the number of memory allocations and the number of memory de-allocations increases from one test to the next. Each candidate memory area is then evaluated further to identify any specific memory leaks within the memory area.

### BRIEF DESCRIPTION OF THE DRAWINGS

FIGS. 1A and 1B are block diagrams depicting an example system for identifying memory leaks in a computer system.

FIG. 2 depicts an example memory configuration illustrating memory pools.

FIG. 3 is a flow diagram depicting an example method for identifying memory pools that are likely to include one or more memory leaks.

FIG. 4 is a flow diagram depicting another example method for identifying memory pools that are likely to include one or more memory leaks.

FIG. 5 is a flow diagram depicting an example method for identifying memory leaks in one or more memory pools.

FIG. 6 is a flow diagram depicting an example method for identifying allocation-free pairs from captured traceback information.

FIGS. 7 and 8 illustrate example graphical user interfaces for displaying the results of an automated memory leak evaluation.

FIG. 9 is a block diagram depicting another example operation of the automated memory leak evaluation software.

### DETAILED DESCRIPTION

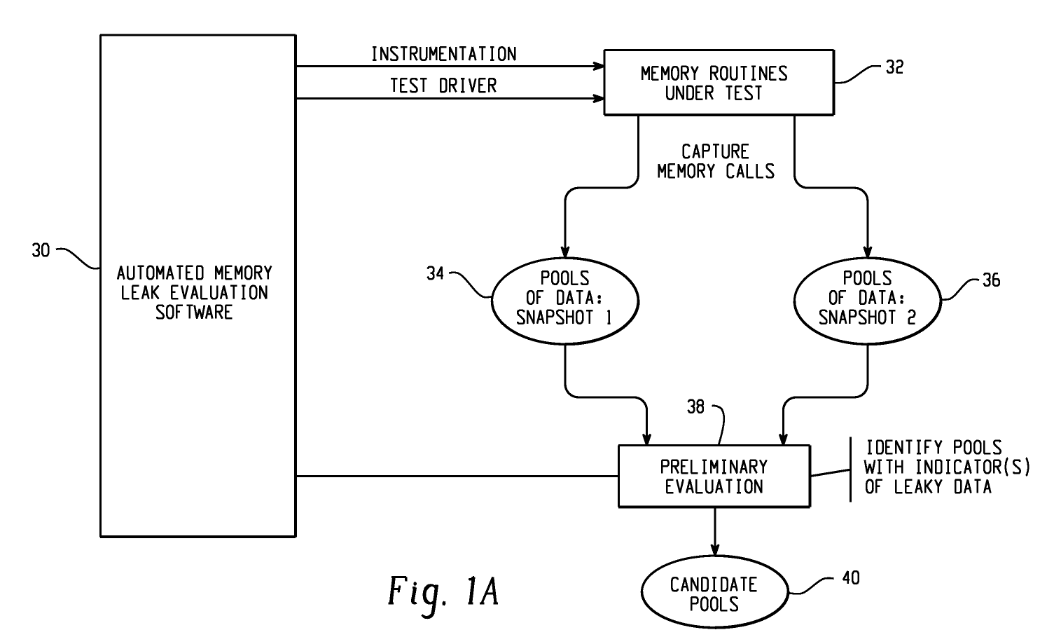

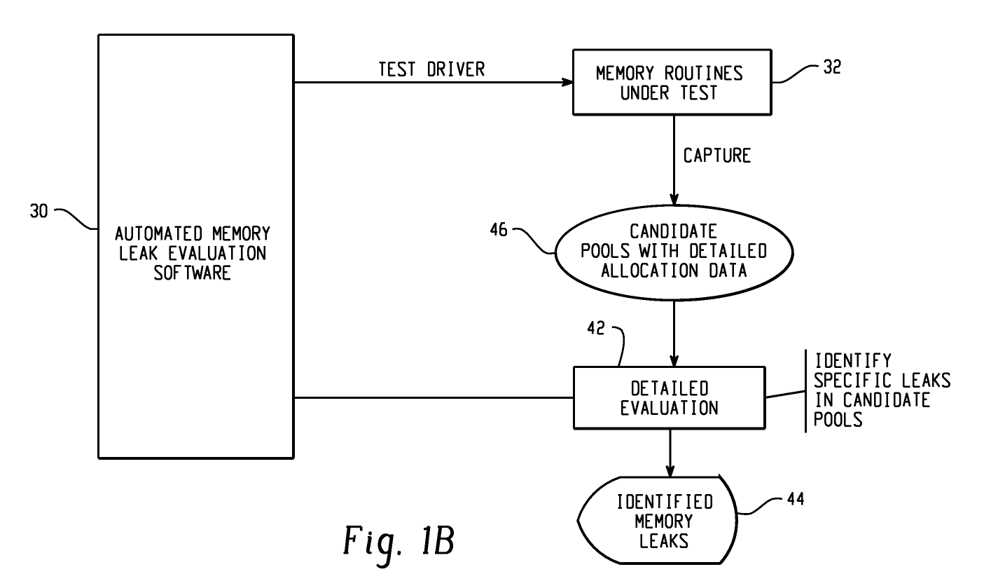

FIGS. 1A and 1B are block diagrams depicting an example system for identifying memory leaks in a computer system. The system includes automated memory leak evaluation software 30 that is used to identify memory leaks in one or more memory routines 32. The memory routines 32 may include any software routine that is executed by a computer operating system or software application in order to allocate and de-allocate memory. FIG. 1A depicts a first half of the evaluation process performed by the automated memory leak evaluation software 30 and FIG. 1B depicts the second half of the evaluation process.

The automated memory leak evaluation software 30 may include computer code that is inserted into the memory routines 32 in order to capture the data for evaluation. For instance, the automated memory leak evaluation software 30 may be inserted into a memory routine 32 using a software instrumentation program, such as the Aprobe software sold by OC Systems, Inc. of Fairfax, Va. The evaluation software 30 should be inserted into every memory routine 32 that is used by the operating system or software application under test. For example, the evaluation software 30 may be inserted into pool/heap create and destroy routines, pool/heap reset routines, memory allocation, reallocation and free routines, and any other application routine that deals with memory. In another example, the automated memory leak evaluation software 30 may be permanently added to the memory routines 32 by the software developer so that the evaluation software 30 is part of the shipped system. In this case, the evaluation software 30 should be configured so that it is turned off after being executed by the customer.

In addition to the instrumented code, the automated memory leak evaluation software 30 also includes interface software that is used to communicate with the instrumented code in order to send commands and receive data. The interface software may also be used to receive user input and to display captured data.

With reference first to FIG. 1A, after the evaluation software 30 has been instrumented, a plurality of tests are executed by sending commands to the instrumented software to capture snapshots 34, 36 of the current state of the memory. In addition, before capturing a snapshot of the memory data, the test may be executed one or more times in order to prime the system. Priming the system helps to ensure that the system has reached a steady state before memory snapshots are captured. For instance, when the test is first executed, one or more of the memory routines 32 may allocate memory that is not intended to be freed during the pendency of the tests, and are therefore not memory leaks. These types of allocations should not appear after the test has been run one or more initial times to prime the system. Typically, only one or two iterations of the test are necessary to prime the system.

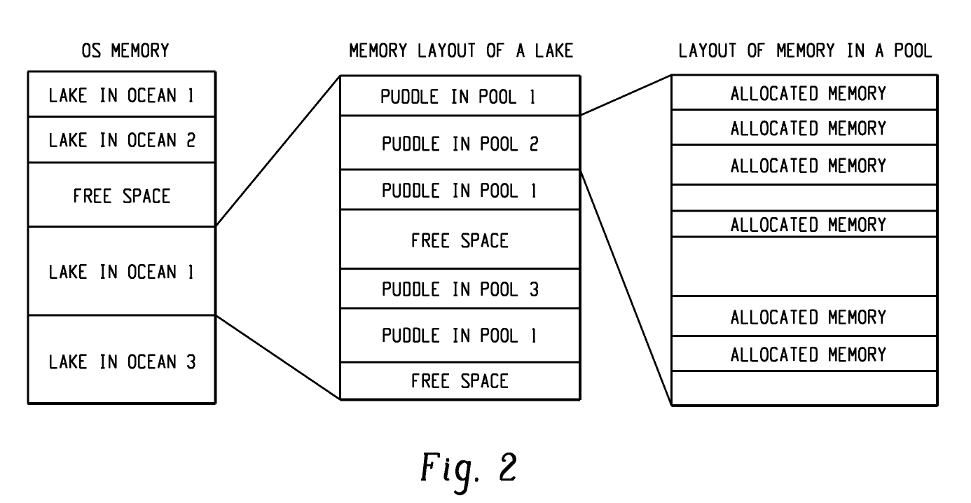

Once the system has been primed, the test is executed two more times to capture first and second memory snapshots 34, 36. As illustrated, the captured memory data may be based on memory pools or heaps. An example memory configuration illustrating memory pools is illustrated in FIG. 2. It should be understood, however, that other memory management configurations could also be utilized in which memory is allocated from a memory area other than a pool or heap. With reference again to FIG. 1, the memory snapshots 34, 36 may include the pool identification information and the number of allocations and frees within the pool.

The memory snapshots 34, 36 are then compared by the automated memory leak evaluation software 30 to perform a preliminary evaluation 38 to identify candidate pools 40 that include one or more indicators of a memory leak. For example, a pool may be identified as a memory leak candidate pool 40 if the difference between the number of allocations and the number of frees increases between the two memory snapshots 34, 36.

With reference now to FIG. 1B, the automated memory leak evaluation software 30 performs a more detailed evaluation 42 of the candidate pools 40 to identify the individual memory leaks 44. More specifically, the automated memory leak evaluation software 30 causes another execution of the memory test to capture a more detailed memory snapshot 46 for the candidate pools 40. During this run, the test captures the address, size, type of operations and traceback information for every memory operation that stores data to one or more of the candidate pools. The memory snapshot 46 is then evaluated 42 to identify memory leaks in the form of memory addresses that are allocated by a memory routine and are not subsequently de-allocated (freed). In this manner, the detailed analysis 42 only needs to be performed on the candidate pools 40 and not on every memory pool in the system.

As an example of a detailed evaluation 42 that may be performed to identify individual memory leaks within a candidate pool 40, consider the following hypothetical set of captured pool data.

| ITEM | | | | |
|---|---|---|---|---|
| NO. | OPERATION TYPE | ADDRESS | SIZE | TRACEBACK |
| 1 | ALLOC. | 0x12345678 | 256 | traceback info 1 |
| 2 | ALLOC. | 0x23456789 | 15 | traceback info 2 |
| 3 | FREE | 0x12345678 | ?? | traceback info 3 |
| 4 | FREE | 0x33333333 | ?? | traceback info 4 |
| 5 | ALLOC. | 0x44444444 | 123 | traceback info 5 |
| 6 | ALLOC. | 0x55555555 | 100 | traceback info 6 |
| 7 | FREE | 0x23456789 | ?? | traceback info 7 |
| 8 | FREE | 0x55555555 | ?? | traceback info 4 |
| 9 | ALLOC. | 0x66666666 | 100 | traceback info 6 |

In the above example, nine memory operations have been captured for a candidate pool. A comparison of the data items shows allocation-free pairs between data items 1 and 3, between data items 2 and 7, and between data items 6 and 8. These six data items may therefore be removed from consideration as memory leaks. The traceback identifications for the remaining three data items (4, 5 and 9) are then compared to determine if any match the traceback identification of an identified allocation-free pair. In this example, the traceback identification for data item 4 matches the traceback identification for item 8, and the traceback identification for data item 9 matches the traceback identification for item 6. Therefore, because items 6 and 8 have been identified as an allocation-free pair, it may be inferred from the traceback information that items 4 and 9 are also an allocation-free pair. The only remaining unpaired memory allocation (item 5) is flagged as being a memory leak.

In the above example, if the detailed analysis does not result in every captured memory de-allocation (free) being paired with a memory allocation, then not enough data has been captured. In this situation, the test should be executed at least twice while the memory data 46 is being captured to ensure that sufficient data is provided to perform the evaluation 42.

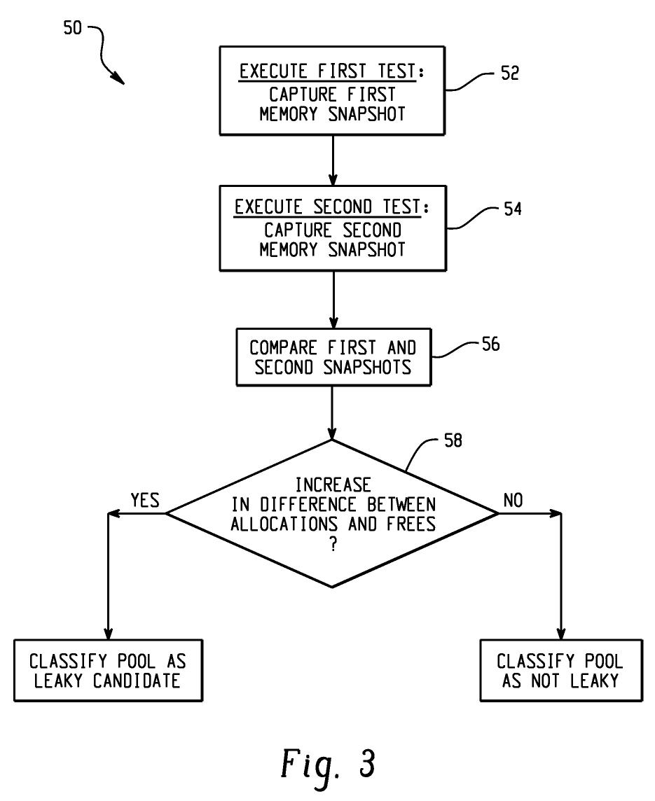

FIG. 3 is a flow diagram depicting an example method 50 for identifying candidate memory pools that are likely to include one or more memory leaks. In step 52, a first test is executed on one or more memory routines of an operating system or software application to capture a snapshot of all of the memory allocations and de-allocations (frees) that are performed during the testing period. A second test is then executed on the same memory routine(s) in step 54 to capture a second snapshot of the memory allocations and de-allocations during the second testing period. The tests performed in steps 52 and 54 may, for example, be executed using computer code that is inserted into the memory routines under test using a software instrumentation process. For instance, computer code configured to execute the test and capture the memory snapshots may be instrumented into memory allocation, reallocation and free routines, as well as other memory-related application or operating system routines.

In step 56, the first and second memory snapshots are compared to identify memory pools that are likely to include memory leaks. As shown in step 58, a memory pool may be identified as being likely to include memory leaks if the difference between the number of memory allocations and the number of memory de-allocations (frees) increased from the first memory snapshot to the second memory snapshot.

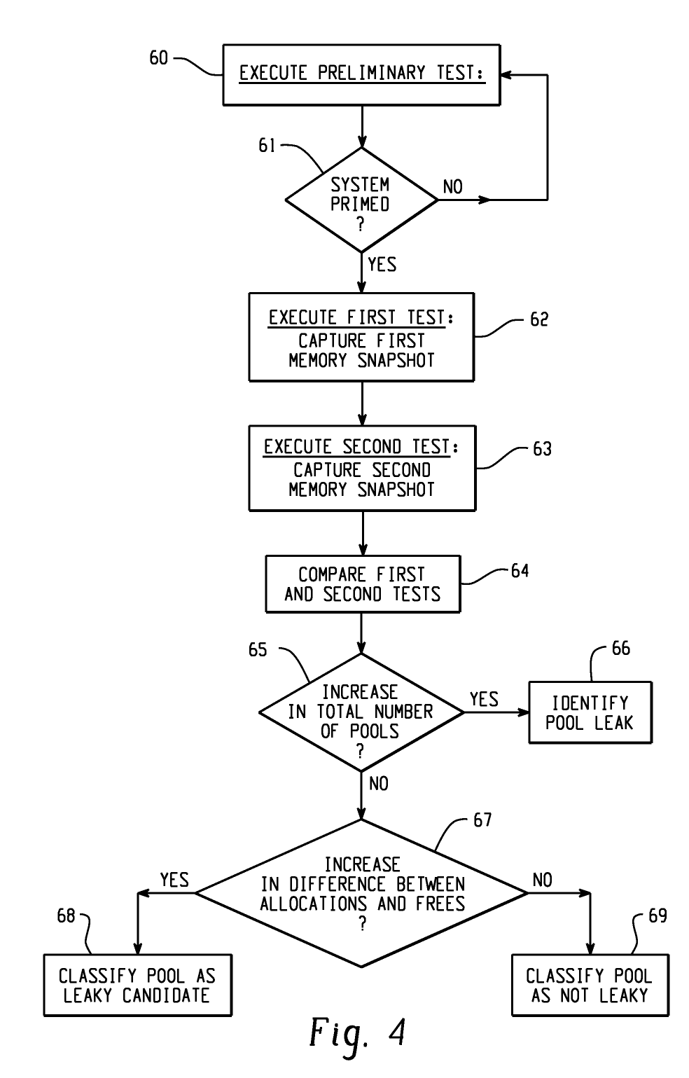

FIG. 4 is a flow diagram depicting another example method 60 for identifying memory pools that are likely to include one or more memory leaks. In this example, the memory routine(s) under test are primed before the first and second memory snapshots are captured. Specifically, a preliminary test of the memory routine(s) is executed in step 62. The method then determines in step 64 whether the system has reached a steady state. If a steady state has not been reached, then the system is not primed and the method returns to step 62. Once the system has been primed, the method proceeds to identify candidate pools that are likely to include memory leaks using the same method as described above with reference to FIG. 3.

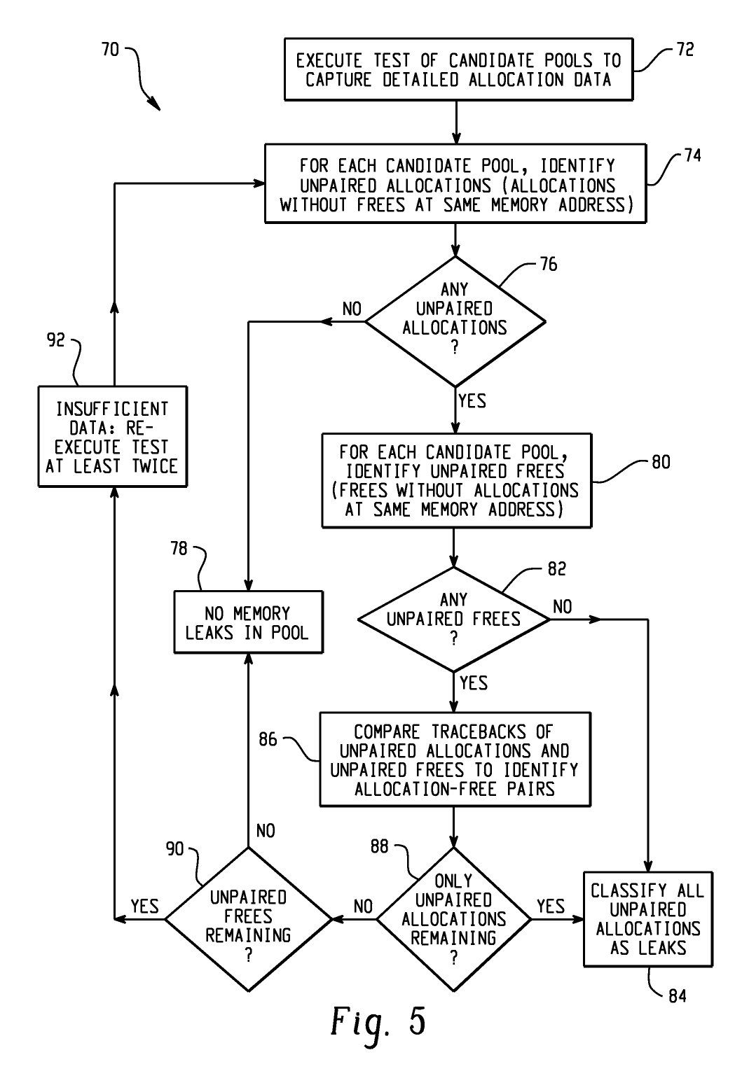

FIG. 5 is a flow diagram depicting an example method 70 for identifying memory leaks in one or more memory pools. The method of FIG. 5 may, for example, continue from the methods of FIGS. 3 or 4 to identify specific memory leaks in one or more candidate pools. In step 72, another test is executed on the one or more memory routines to capture a more detailed memory snapshot for the candidate pool(s). For instance, the test executed in step 72 may be configured to capture the address, size, type of operation and traceback information for every memory operation relating to one or more of the candidate pool(s).

In step 74 and 76, the detailed memory snapshot is evaluated to identify whether the candidate pool(s) includes any unpaired memory allocations. An unpaired memory allocation is a memory address that is allocated and not subsequently freed during the pendency of the test. If there are no unpaired memory allocations, then there are not memory leaks in the pool(s) and the method ends at step 78. Otherwise, if one or more unpaired memory allocations are identified, then the method proceeds to step 80.

In steps 80 and 82, the detailed memory snapshot is further evaluated to identify whether the candidate pool(s) includes any unpaired frees, where an unpaired free is a memory de-allocation that does not have a memory allocations at the same memory address during the pendency of the test. If there are no unpaired frees, then all of the memory addresses identified in step 76 as having unpaired memory allocations are classified as memory leaks at step 84. Otherwise, if one or more unpaired frees are identified, then the method proceeds to step 86.

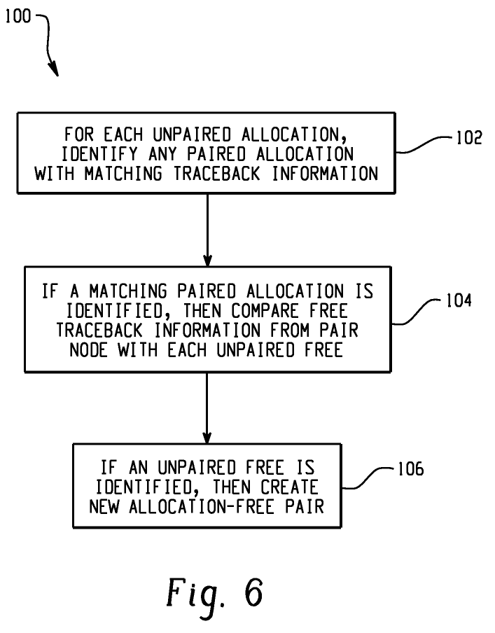

In step 86, the captured traceback information for the unpaired allocations and the unpaired frees is evaluated to identify any additional allocation-free pairs within the detailed memory snapshot. An example method for identifying allocation-free pairs from the captured traceback information is described below with reference to FIG. 6. In steps 88 and 90, the method determines whether there are any unpaired allocations or frees remaining from the memory snapshot. If only unpaired allocations are remaining (no unpaired frees), then all of the unpaired allocations are classified as memory leaks at step 84. If there are either unpaired frees or a mix of unpaired allocations and unpaired frees remaining, then the snapshot did not include enough data to perform a sufficient evaluation and the method proceeds to step 92. If at steps 88 and 90 there are no unpaired allocations or unpaired frees remaining from the memory snapshot, then there are no memory leaks in the pool and the method ends at step 78.

If it is determined that the test did not capture sufficient data to complete the evaluation, then at step 92 the test is re-executed at least twice while the memory snapshot is captured to provide a better chance of capturing matching allocations and frees. The method then returns to step 74 using the new memory snapshot.

FIG. 6 is a flow diagram depicting an example method 100 for identifying allocation-free pairs from captured traceback information. The method of FIG. 6 may, for example, be performed at step 86 of FIG. 5. In step 102, each unpaired memory allocation in the memory snapshot is compared with the paired allocations to identify any paired allocation having a traceback identification that matches the traceback identification of an unpaired allocation. If a match is identified, then the free traceback identification from the identified pair node is compared at step 104 to the traceback identifications for each unpaired free in the memory snapshot to identify a match. If a matching unpaired free is identified, then in step 106 the unpaired allocation from step 102 is paired with the unpaired free from step 104.

The method of FIG. 6 may be further explained with reference to the example evaluation described above with reference to FIG. 1B. In that example, data items 4, 5 and 9 remained unpaired after the initial evaluation. By comparing the traceback identifications for the unpaired allocations (data items 5 and 9) with the traceback identifications for the paired allocations (data items 1, 2 and 6), it is determined that the traceback identification for unpaired data item 9 matches the traceback identification for paired data item 6. Data item 6 is an allocation paired with the free at data item 8. Therefore, the traceback identification for data item 8 is compared with the remaining unpaired free at data item 4, and a match is identified. It may therefore be inferred from the traceback information that items 4 and 9 are also an allocation-free pair.

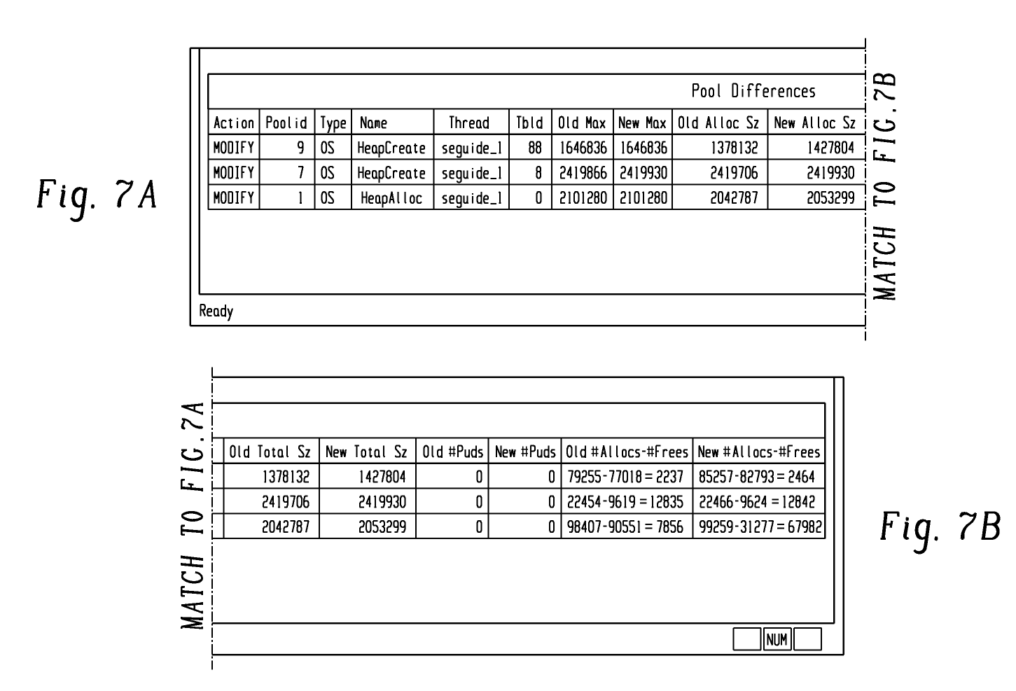

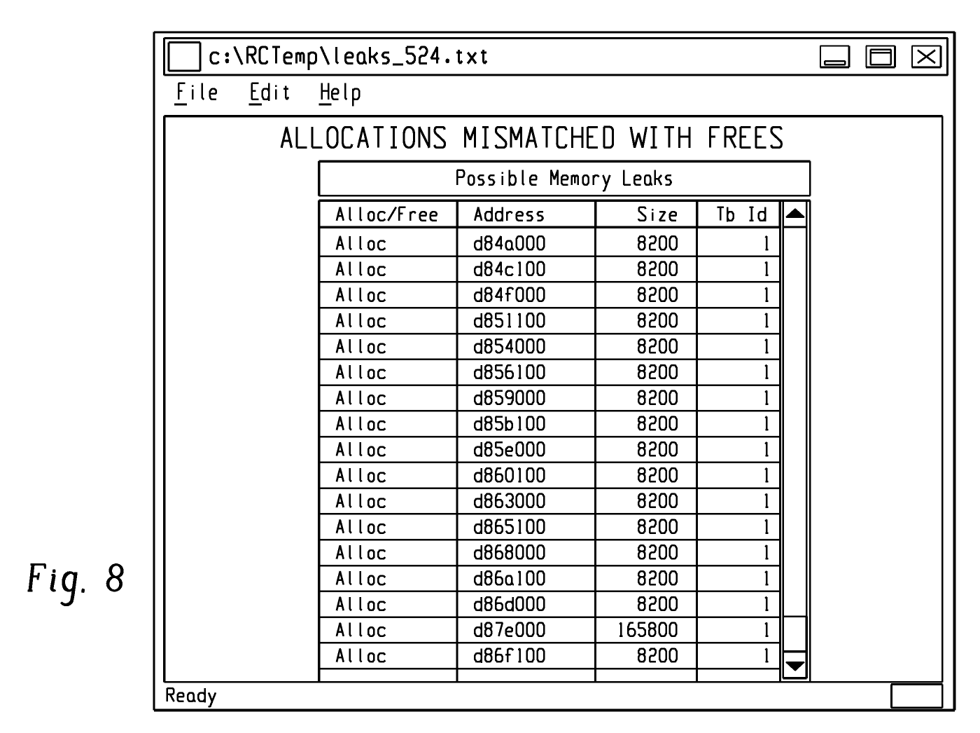

FIGS. 7 and 8 illustrate example graphical user interfaces for displaying the results of an automated memory leak evaluation. The graphical user interfaces depicted in FIGS. 7 and 8 may, for example, be displayed by the automated memory leak evaluation software 30 of FIGS. 1A and 1B. FIG. 7 illustrates an example graphical user interface for displaying information relating to candidate pools that have been identified as likely having memory leaks. In the illustrated example, three candidate pools have been identified (Poolid 9, 7 and 1). As illustrated in the last two columns on the display, the difference between the number of allocations and the number of frees in these three pools has increased between the first memory snapshot (Old#Allocs-#Frees) and the second memory snapshot (New#Allocs-#Frees). As illustrated, other memory-related information may also be displayed.

FIG. 8 illustrates an example graphical user interface for displaying information regarding specific memory leaks identified from the memory leak evaluation. In this example, a number of unpaired allocations have been identified as memory leaks. An examination of the displayed results, however, shows that this is a single memory leak because all of the traceback identifications (TbId) are the same.

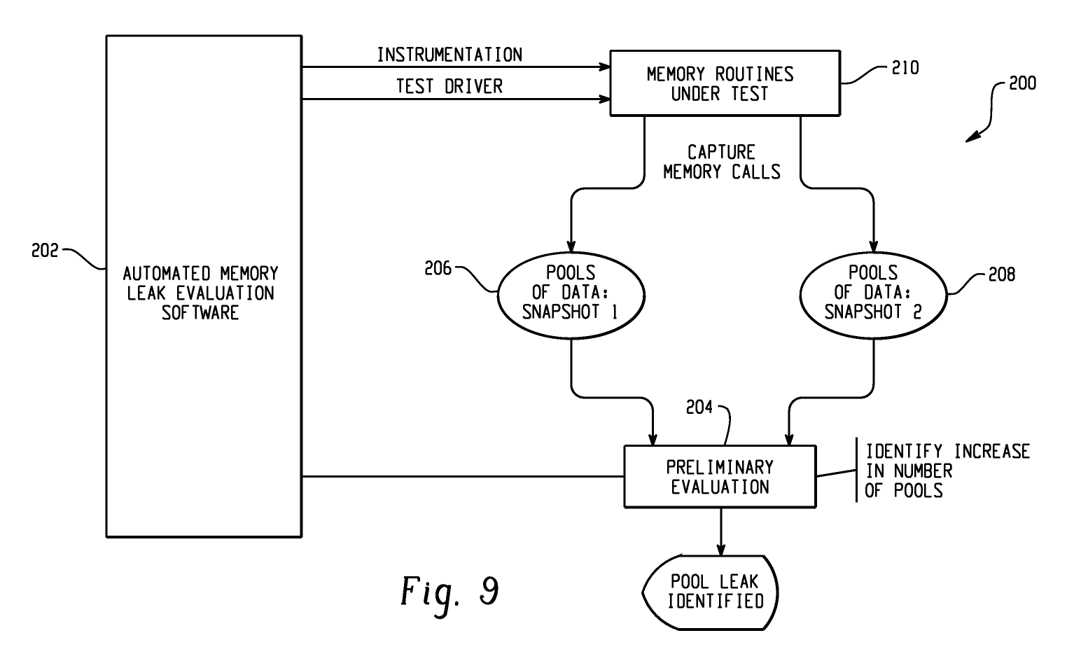

This written description uses examples to disclose the invention, including the best mode, and also to enable a person skilled in the art to make and use the invention. The patentable scope of the invention may include other examples that occur to those skilled in the art. For example, FIG. 9 is a block diagram depicting another example operation of the automated memory leak evaluation software 202. In this example, the preliminary evaluation 204 performed by the automated memory leak evaluation software 202 determines that the total number of pools has increased from the first memory snapshot 206 to the second memory snapshot 208. This indicates that the memory routine(s) under test 210 is leaking entire pools.

It is further noted that the systems and methods described herein may be implemented on various types of computer architectures, such as for example on a single general purpose computer or workstation, or on a networked system, or in a client-server configuration, or in an application service provider configuration.

It is further noted that the systems and methods may include data signals conveyed via networks (e.g., local area network, wide area network, internet, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It is claimed:

1. A method for identifying memory leaks in a computer system, comprising:
execute testing software that is embedded within one or more memory routines of the computer system to cause at least two successive tests of the one or more memory routines during which the one or more memory routines perform memory operations to allocate and de-allocate memory from a plurality of memory areas;
capturing information regarding the memory operations performed by the one or more memory routines during the at least two successive tests, the captured information identifying at least a number of memory allocations and a number of memory de-allocations performed by the one or more memory routines with respect to each of the plurality of memory areas;
comparing the captured information from the at least two successive tests to identify one or more candidate memory areas from the plurality of memory areas, wherein a candidate memory area is identified by determining that the difference between the number of memory allocations and the number of memory de-allocations in the candidate memory area is increasing during the at least two successive tests;
for each candidate memory area, identifying any memory leaks within the candidate memory area, wherein a memory leak is identified if the candidate memory area includes a memory address that is allocated but that is not de-allocated; and
generating an output that identifies any identified memory leaks.

2. The method of claim 1, wherein the one or more candidate memory areas are identified using a candidate memory area identification method comprising:
executing a first test of the one or more memory routines to capture a first set of memory allocations and de-allocations performed by the one or more memory routines with respect to each of the plurality of memory areas;
executing a second test of the one or more memory routines to capture a second set of memory allocations and de-allocations performed by the one or more memory routines with respect to each of the plurality of memory areas;
comparing the first and second sets of memory allocations and de-allocations to identify memory areas in which the difference between the number of memory allocations and the number of memory de-allocations increases from the first test to the second test.

3. The method of claim 2, wherein the candidate memory area identification method further comprises:
executing the one or more tests of the memory routines prior to executing the first and second tests in order to allow the memory allocations in the plurality of memory areas to stabilize.

4. The method of claim 1, wherein one or more memory leaks within each candidate memory area are identified using a memory leak identification method comprising:
executing an additional test of the one or more candidate memory areas to capture additional information regarding memory operations performed by the one or more memory routines;
identifying one or more unpaired memory allocations in a candidate memory area, wherein an unpaired memory allocation is a memory allocation without a corresponding memory de-allocation at the same memory address in the candidate memory area;
determining if the candidate memory area includes one or more unpaired memory de-allocations, wherein an unpaired memory de-allocation is a memory de-allocation without a corresponding memory allocation at the same memory address in the candidate memory area; and
if the candidate memory area does not include one or more unpaired memory de-allocations, then classifying all of the unpaired memory allocations as memory leaks.

5. The method of claim 4, wherein the memory leak identification method further comprises:
determining that the candidate memory area does not include any memory leaks if there are no unpaired memory allocations in the candidate memory area.

6. The method of claim 4, wherein the memory leak identification method further comprises:
if the candidate memory area includes both one or more unpaired memory allocations and one or more unpaired memory de-allocations, then comparing tracebacks to identify any additional pairs.

7. The method of claim 6, wherein the memory leak identification method further comprises:
if no memory de-allocations remain unpaired after tracebacks are compared, then classifying any remaining unpaired memory allocations as memory leaks; and
if no memory allocations or memory de-allocations remain unpaired after tracebacks are compared, then determining that the candidate memory area does not include any memory leaks.

8. The method of claim 7, wherein the memory leak identification method further comprises:
if one or more memory de-allocations remain unpaired after tracebacks are compared, then determining that the additional test of the one or more candidate memory areas did not capture sufficient information; and
executing at least two successive additional tests of the one or more candidate memory areas to capture the additional information over a longer period of time.

9. The method of claim 1, further comprising:
inserting the testing software into the one or more memory routines using a software instrumentation program.

10. The method of claim 1, wherein the plurality of memory areas are memory pools or heaps.

11. An automated memory leak evaluation system, comprising:
one or more memory routines stored on a computer readable medium and executable by a computer system to perform memory operations to allocate and de-allocate memory from a plurality of memory areas;
testing software that is embedded into the one or more memory routines, the testing software being configured to cause the one or more memory routines to perform memory allocation and de-allocation operations with respect to the plurality of memory areas;
the testing software being further configured to capture information during at least two successive tests of the one or more memory routines, the captured information identifying at least a number of memory allocations and a number of memory de-allocations performed by the one or more memory routines with respect to the plurality of memory areas; and
memory leak evaluation software configured to communicate with the testing software to receive the captured information;
the memory leak evaluation software being further configured to compare the captured information from the at least two successive tests to identify one or more candidate memory areas from the plurality of memory areas, wherein a candidate memory area is identified by determining that the difference between the number of memory allocations and the number of memory de-allocations in the candidate memory areas increases during the at least two successive tests;
the memory leak evaluation software being further configured to evaluate the candidate memory areas to identify any memory leaks.

12. The automated memory leak evaluation system of claim 11, wherein a memory leak is identified if the candidate memory area includes a memory address that is allocated but that is not de-allocated.

13. The automated memory leak evaluation system of claim 11, wherein the memory leak evaluation software causes the testing software to execute the at least two successive tests.

14. The automated memory leak evaluation system of claim 13, wherein the memory leak evaluation software causes the testing software to execute an additional test of the one or more candidate memory areas to capture additional information regarding memory operations performed by the one or more memory routines, and wherein the additional information is used by the memory leak evaluation software for the purpose of identifying the memory leaks.

15. The automated memory leak evaluation system of claim 14, wherein the additional information includes the number of memory allocations and the number of memory de-allocations in the one or more candidate memory areas and also includes traceback information for each of the memory allocations and memory de-allocations in the one or more candidate memory areas.

16. The automated memory leak evaluation system of claim 11, wherein the testing software is inserted into the one or more memory routines using a software instrumentation program.

17. The automated memory leak evaluation system of claim 11, wherein the plurality of memory areas are pools or heaps.
